(19) United States
(12) Patent Application Publication
(10) Pub. No.: US 2008/0138142 A1
(43) Pub. Date: Jun. 12, 2008

(54) Masking masking solution and masking masking solution applicator

(76) Inventor: Eugene Pressman, Venice, CA (US)

Correspondence Address: SCHULTE ROTH & ZABEL LLP;ATTN: JOEL E. LUTZKER, 919 THIRD AVENUE, NEW YORK, NY, 10022, US

(21) Appl. No.: 11/635,104

(22) Filed: Dec. 6, 2006

(51) Int. Cl. B43M 11/06; B43K 5/00

(52) U.S. Cl. 401/183; 401/205

(57) ABSTRACT

A disposable paint masking product/item/tool consisting of an aqueous based paintable, peelable liquid solution contained in a hand held applicator intended for the purpose of masking any window glass, door glass, or other conducive surface when painting muntins, sash, rails, stiles or any trim that might be adjacent to such window or door glass. The solution, which air dries, acts as a paint barrier on above mentioned surfaces to protect from stray paint when adjacent surfaces such as muntins, sash, etc. are intended to be painted, then peels off upon completion. The solution resides in a disposable cylindrical-like container of resilient material (squeeze tube, aerosol can or other) and is despensed through a detachable head cap (threaded or friction attached) of molded plastic material or other having an affixed porous applicator pad at the end surrounded on all four edges by non-porous material so as to prevent the application of the masking solution onto the muntins, stiles, etc.

### BACKGROUND

A color changing masking solution for application to window panes to provide a masking along the inside of window dividers, stiles or rails on windows or French doors, and a disposable device for applying same which can be used with one hand. The application device includes a cylindrical body forming a container, a removable cap with an angled plate bearing a porous pad; and a thin plastic layer on the cap running along the edge of the porous pad. Alternatively, the pad may have a coating along the edge precluding the need for the plastic layer on the cap surrounding the edge of the porous pad.

### FIELD OF THE INVENTION

The Invention herein relates to a masking solution for application to window panes along the inside of the window dividers (muntins) to provide a masking when painting the muntins, stiles, trim, or rails on windows or French doors, and a device for dispensing same. More specifically the invention involves a hand held device for one handed application of the masking solution. The invention also relates to a color changing masking solution.

### BACKGROUND OF THE INVENTION

When painting muntins, stiles or rails one is faced with a challenge of painting only the desired area and not the connecting glass or other materials along the insides of such areas. Painting free hand would normally result in stray paint, which would have to be removed by post paint razor scraping or other potentially damaging techniques.

There are currently four different ways or techniques to painting the stiles, rails and dividers of a window without getting paint on the glass. These methods break down into 1) masking with tape prior to painting; 2) liberally painting freehand and not concerning oneself with overspill, but scraping the overspill later when dry with a single edged razor; 3) painting freehand with great care so as to hopefully avoid having to scrape afterwards; and 4) newly marketed aqueous based paintable, peelable coatings the are sprayed or brushed on glass and wood together, then scored and pleeled as a sheet from each pane afterwards. The present invention addresses the deficiencies in each of these methods while utilizing the best aspects of each, resulting in a faster, safer, less labor intensive task of painting, but with quality that rivals the best of the above techniques of them.

Traditional use of masking tape is not satisfactory, as it can be difficult to deploy evenly and may result in inconsistent masking coverage. Application of Masking Tape is a laborious task, so much so that most do-it-yourselfers abandon this technique when painting windows, and professionals almost never use it. A piece of tape must be torn and fitted to each side of each pane of glass—that's 4 panes per sash, two sashes on average per window . . . 32 pieces of tape torn and fitted per average window. Moreover, tape cannot bend, so if the divider is not perfectly straight, if it has any warping or cracks, the tape will not follow the line of the divider properly, allowing for an uneven seam of paint as well as extra labor repeatedly putting on and removing each piece trying to get a good seam. Applying tape requires two hands, making it difficult if not hazardous when working on a ladder. Finally, paint can seep in behind the tape, even if applied properly.

The present invention, being a liquid solution, is applied with ease and in far less time. Further, because it's liquid the solution can uniformly “hug” the line of the divider or trim giving a flawless seal. Once the solution dries no paint can seep in under. Moreover, when applied using the device of this invention, it requires use of only one hand to apply the masking solution.

While other applicators have been known to apply masking to solid materials, such known devices have not been satisfactory, as they do not apply masking to a window. Other possible means of applying the present masking to a window, such as a brush, roller or power sprayer, would also be unacceptable, as they are difficult to use when on a ladder, or when the window is in a hard to reach area and they are not effective when the muntin is warped, bowed or cracked.

With the device of the present invention, the masking solution is uniquely dispensed via a disposable applicator which applies the solution to the glass only “hugging” the line of the muntin, can be easily grasped and peeled and using far less of the solution. And because the existing peelable coating products are best applied via spray gun, the do-it-yourselfer or handyman are not the intended end users of this product.

Previously known paint applicators have been designed to apply paint in such difficult areas in an attempt to avoid the need for masking. However, such devices are not designed for the application of masking solution, and simply improved the accuracy of free hand painting, and often required masking or post-painting clean up as paint drips onto the areas normally requiring masking. Further, such devices require cleaning and refilling and often require both hands to use.

Previously known masking solutions have only notified the user when the masking was dry by changing from white to clear or opaque to translucent, and have not used clear color denotation. The color change of the present invention makes it readily obvious when the solution has dried, and the color provides an easily seen masked area.

### SUMMARY OF THE INVENTION

MagikMask (formerly known as Trimstick) is a hand held tool similar in size to a toothpaste tube, dispensing a thin bead of masking solution approximately one inch wide to be applied onto window panes along the inside of the window dividers (muntins) to provide a masking when painting the muntins, stiles or rails on windows or French doors. Once dry, the masking solution acts as a protective barrier preventing paint from touching glass, and then peels off each pane in one piece. Although the product is described specifically with respect to glass surface, the masking solution may be applied to any other surface to be protected during painting that is conducive to having a substance peeled off of it.

The primary object of the invention is to provide a paintable, peelable masking solution used as a masking barrier and a dispenser for same.

One object of this invention is to provide for an easy to apply masking solution which when dry provides a masking, but is easily removed when painting is complete.

Another object of this invention is to provide a color changing masking solution which is one opaque color when applied, but changes to a second transparent color when it is dry.

Another object of this invention is to provide a dispenser and/or applicator for the masking solution which is easy to use.

Another object of the invention is to provide a dispenser for such masking solution which can be used one handed for improved security when using it on a ladder.

Yet another object of the invention is to provide a dispenser for such masking solution which can hug the edge of the muntin regardless of whether it is bowed, warped or cracked, so as to provide a near flawless seal.

Yet another object of the invention is to provide a dispenser for masking solution which would make the job of painting windows faster, easier, and more exact than previously existing methods.

Yet another object of the invention is to provide a dispenser for masking barrier masking solution which is disposable, thereby eliminating cleaning the dispenser or restocking the masking solution.

Although the present invention is described specifically with respect to glass surface, the masking solution may be applied to any other surface to be protected during painting that is conducive to having something peeled off of it.

In an aspect of this invention a device is provided for. This device includes a container made of plastic or a flexible material, such as a squeeze tube for storing masking solution, a removable applicator cap for dispensing the masking solution, an angled plate on the cap with a porous pad on it for absorbing and evenly distributing the masking solution, and a threaded removable cap with a thin plastic layer which forms a barrier between the porous pad and any adjacent surfaces other than the surface to be painted on.

As an alternative to the thin plastic layer, the porous pad may have a coating along the outer edge to separate it from adjacent surfaces other than the surface to be masked.

In another aspect of this invention a device is provided for which includes a container made of metal, plastic or a hard material, an aerosol canister for storing the masking solution, a beveled tip for dispensing the masking solution with an angled plate with a porous pad on it for absorbing and evenly distributing the masking solution, and a friction attached cap.

The above and other objects and advantages will become more apparent from the following description and accompanying drawings forming part of this application.

### BRIEF DESCRIPTION OF THE DRAWING

The invention is illustrated by way of example and not limitation and the figures of the accompanying drawings in which like references denote like or corresponding parts:

FIGS. 1a-d are views of a preferred embodiment of the device of this invention, showing approximate proportions.

FIG. 2a-d are diagrams of the removable applicator cap showing the elements thereof.

FIG. 3 is a cross section of the applicator cap and porous pad of the device of the present invention.

FIG. 4 is a diagram showing the use of the devise of the present invention being used to apply the masking solution of the present invention to a window.

FIG. 5 is a diagram of a window showing how the masking solution of the present invention would appear after applied to a window using the device of the present invention.

### DETAILED DESCRIPTION OF INVENTION

In the following description of exemplary embodiments, reference is made to the accompanying drawings which form a part hereof, and in which is shown by way of illustration a display which may be used when the invention is practiced. It is understood that other displays may be utilized, as display, operational and structural changes may be made without departing from the scope of the present invention.

Generally, the present invention provides for a color changing masking solution to be applied as a masking and a device for applying same. The invention provides for an easy to use device which would reduce the time and difficulty of a painting job involving windows or other structures on which paint is not desired. More particularly, the invention is directed to the nature of the masking solution and the dispenser used to apply it properly and easily.

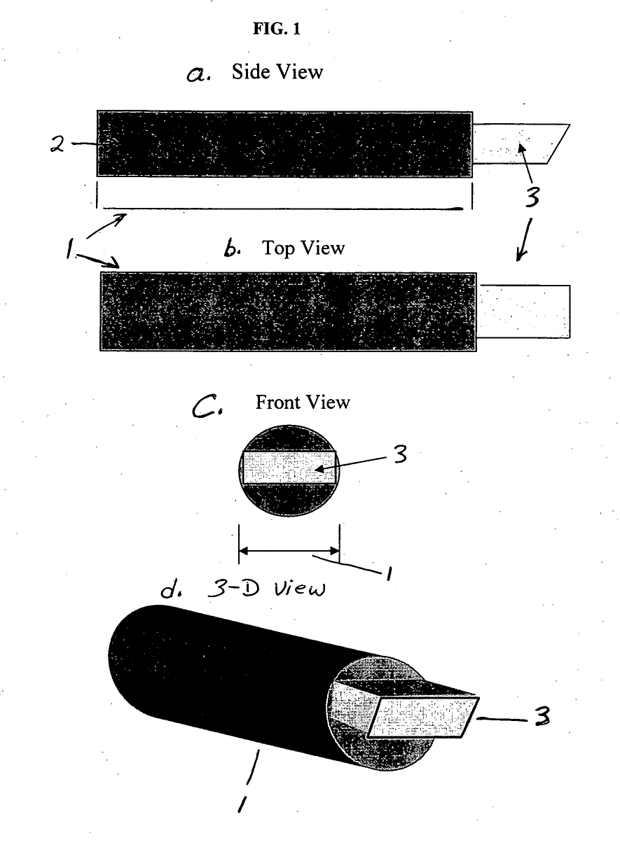

In accordance with the invention and as shown in FIG. 1, the device of this invention consists of a cylindrical body 1, an internal storage 2 for the masking solution, and a beveled tip 3.

In a preferred embodiment as shown in FIGS. 1a-d, the device comprises a cylinder 1 approximately 5 to 6 inches in length and 1.25 inches in diameter with a beveled tip 3 approximately 1 inch long.

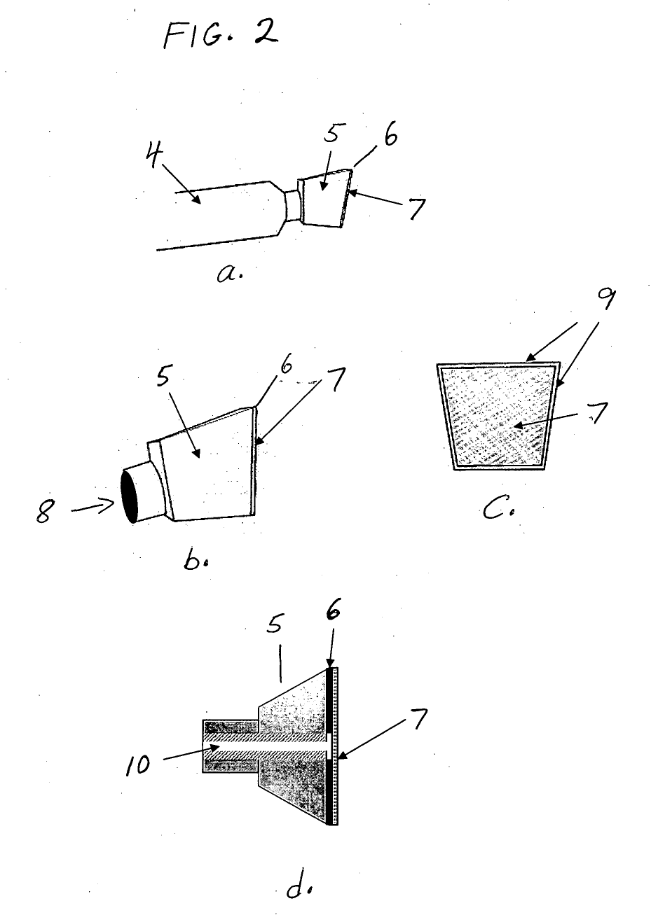

As shown in FIG. 2, in the preferred embodiment, the internal storage consists of a squeeze tube 4 and a detachable molded plastic cap 5 with an angled front plate 6. The detachable cap 5 has a porous pad 7 made of porous felt or flocked foam attached to the angled front plate 6.

As shown in FIG. 2b, the plastic cap 5 is detachably connected to the body of the device by a threaded interface 8.

As shown in FIG. 2c, in the preferred embodiment, the detachable cap 5 has a rim of non-porous material 9 which provides a lip around the porous pad 7 to separate the pad from adjacent surfaces other than the surface to be masked. The plastic rim acts as a thin barrier between the masking solution and the window divider, allowing the masking solution to be evenly to be evenly distributed onto the glass in an even width the same width of the porous pad without being accidentally applied to the wood or other surface to be painted.

As shown in FIG. 2d, the detachable cap 5 has a channel 10 through it for the masking solution to pass through the cap 5 and angled plate 6 into the porous pad 7.

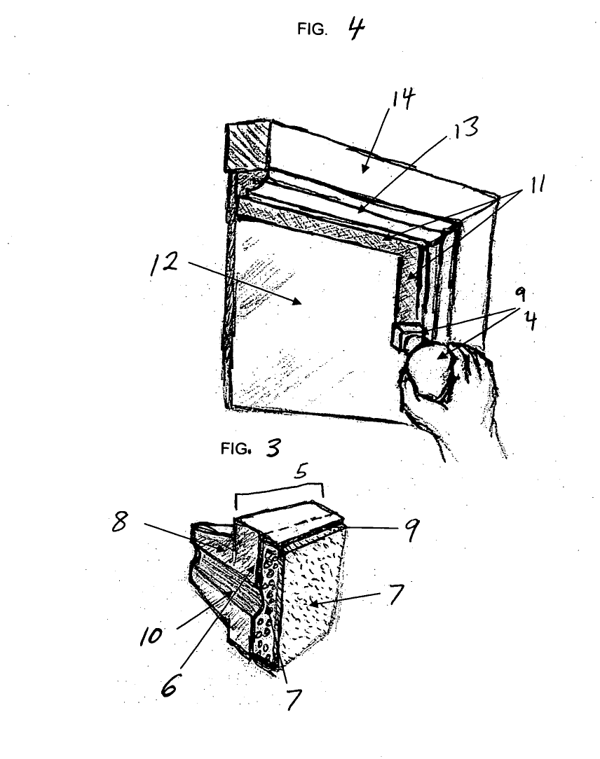

FIG. 3 shows a cross section of the applicator cap 5, showing the threaded connection point 8, the angled plate 6, the porous pad 7, the non-porous layer 9 surrounding the edge of the porous pad 7, and the channel 10 for the passage of the masking solution to the porous pad 7.

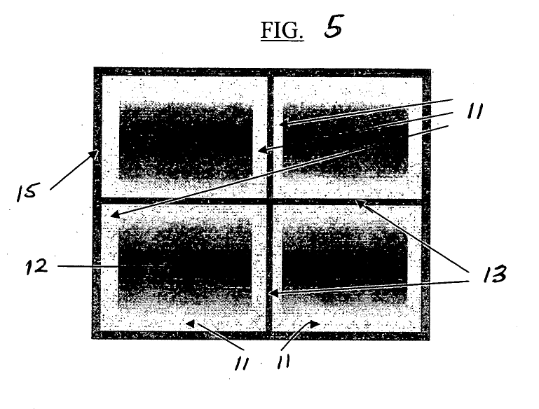

As shown in FIG. 4, in this embodiment, when simple manual pressure is applied to the squeeze tube 4, the masking solution 11 is forced through the channel 10 in the angled plastic plate 6 of the applicator cap 5 into an attached porous pad 7 and thereby onto the window 12. The non-porous layer 9 surrounding the porous pad 7 ensures that the masking solution 11 is only applied to the window 12, and not to the muntin 13 of the window sash 14.

FIG. 5 is a diagram of a window showing how the masking solution 11 of the present invention would appear after applied to a window 12 without applying it to the muntins 13 and frame 15 using the device of the present invention. As shown in the illustration, the masking solution 11 rests evenly in one strip on the glass pane 12 next to the muntin 13, allowing for easy painting of the muntin 13 and the window frame 15.

In the preferred embodiment of this invention, the masking solution is comprised of Flexbond 325 as the primary film formula base, PEG-6 as the release agent, and Bromophenal Blue as the coloring agent together with other minor ingredients.

In the preferred embodiment, the masking solution is stored and applied at the consistency of latex paint.

For the convenience of the reader, the above description focused on representative samples of all possible embodiments that teaches the principles of the invention and conveys the best mode contemplated for carrying it out. The description has not attempted to exhaustively enumerate all possible variations. Other undescribed variations or modifications may be possible. For example, where multiple alternative embodiments are described, in man cases it will be possible to combine elements of different embodiments, or to combine elements of the embodiments described here with other modifications or variations that are not expressly described. Many of those undescribed variations, modifications and alterations are within the literal scope of the following claims and others are equivalent.

I claim:

1) A paintable peelable masking solution usable as a masking barrier.

2) The masking solution of claim 1 wherein the masking solution changes color when it dries.

3) The masking solution of claim 2 wherein the color is opaque green when wet and translucent blue when dry.

4) The masking solution of claim 1 comprising Flexbond 325 as the primary film formula base, PEG-6 as the release agent, and Bromophenal Blue as the coloring agent.

5) A device for dispensing a masking solution usable as a masking comprising:
A cylindrical body composed of plastic or a flexible material;
An internal storage compartment for storing masking solution;
A removable dispenser cap for dispensing the masking solution stored in the device;
And an angular plate bearing a porous pad for even distribution of the masking solution.

6) The device of claim 5 wherein the device can be used one handed.

7) The device of claim 5 wherein the angular plate and porous pad are shaped to hug the edge of a muntin or similar structure, even when the muntin or structure is bowed, warped or cracked.

8) The device of claim 5 wherein the device is disposable.

9) The device of claim 5 wherein the internal storage compartment is a squeeze tube.

10) The device of claim 5 wherein the internal storage compartment is an aerosol can.

11) The device of claim 5 wherein the removable dispenser cap has a thin plastic lip in which the porous pad sits.

12) The device of claim 5 wherein the porous pad has a coating around the edge.

13) The device of claim 5 wherein the porous pad is comprises flocked foam.

14) The device of claim 5 wherein the porous pad comprises porous felt.
